(19) United States
(12) Patent Application Publication
(10) Pub. No.: US 2008/0110870 A1
(43) Pub. Date: May 15, 2008

(54) Heated serving apparatus

(76) Inventors: James Mirkes, Brown Deer, WI (US); Leonard Mirkes, Oshkosh, WI (US); Michael Lemcke, Oak Creek, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/598,525

(22) Filed: Nov. 13, 2006

(51) Int. Cl. H05B 1/00

(52) U.S. Cl. 219/218

(57) ABSTRACT

An apparatus for heating or serving food heating having a non-heated furniture surface and a food-heating surface, adapted to maintain food within a specified temperature range by sensing the temperature of the food heating surface and transmitting data about the temperature to a microprocessor which controls an electrical circuit which supplies heat to the apparatus.

### FIELD OF INVENTION

This invention relates generally to the field of culinary art and, more specifically, to an apparatus that maintains food at a safe temperature.

### BRIEF DESCRIPTION OF THE DRAWINGS

FIG. 1 shows a top perspective view of one embodiment of a heated serving apparatus.

FIG. 2 shows a cross-sectional view of the recessed compartment and the components positioned within the embodiment of the heating serving apparatus shown in FIG. 1 taken along line 2-2.

FIG. 3a is a side view of one embodiment of a control support member of the embodiment of the heated serving apparatus shown in FIG. 1.

FIG. 3b is a front view of one embodiment of a control panel positioned on the control support member shown in FIG. 3a.

FIG. 3c is a front view of one embodiment of a lower panel positioned on the control support member shown in FIG. 3a.

FIGS. 4a and 4b show a side view and top view respectively of one embodiment of a hot plate including an electrical sensor and a groove to facilitate insertion of the electrical sensor.

FIG. 5 is an electrical circuit diagram of one embodiment of the electrical circuitry used to control the heat of the heated serving apparatus.

### BACKGROUND OF THE INVENTION

In private residences, restaurants, hotels, cruise ships and other venues, it is desirable to prolong the period of time over which food may be served warm and to minimize the loss in quality of food and maintain the food at within a safe temperature range. In some venues it is also desirable to place the food which is being served on furniture, such as a table, dining table, hutch, counter, serving display service, or other furnishing or fixture surface. The present invention is capable of functioning as both furniture and a heating apparatus to maintain the food within the safe temperature range.

As used herein, a “wire” is an elongated strand of metal or other conductive material used to carry electricity and electrical signals. As used herein, a wire may be of any gauge which will accomplish a particular function and may include a single wire, a bundle or plurality of wires, or may be single or multi-stranded wire. As used herein, the term wire includes a cord and an insulated flexible electric wire fitted with a plug or plugs.

As used herein, a “non-heated furniture surface” is a non-heated surface that functions as a furniture surface, such as a table-top, counter-top, desk-top, hutch, credenza, or other furniture surface or surface on which objects are commonly placed.

As used herein, a “transformer” is a device used to convert between high and low voltages, to change impedance, or to provide electrical isolation between circuits.

As used herein, a “relay” is an electrically controlled mechanical device in an electrical system that opens and closes an electrical contact to complete or break a circuit.

As used herein, a “microprocessor” is an integrated computer circuit that is capable of receiving and processing digital electrical signals and contains the circuitry necessary to interpret and execute program instructions such as switching a higher voltage current on or off or signaling a relay to open or close.

As used herein, an “electrical box” is a structure made of material which may have insulating qualities which partially or completely encloses electrical components.

As used herein, a “power supply” is a power distribution system, including but not limited to an apparatus or system which converts one form of electrical power to another desired form and voltage (such 120 or 240 volt AC to DC), a switched mode, linear regulator, diode or rectifier type power supply, a battery, chemical fuel cells and other forms of energy storage systems, solar power, generators, alternators, or any type of DC power supply unit.

As used herein, a “power source” is an AC utility power source of electricity, such as a household or commercial utility current having a frequency of 60 hertz, 20 hertz or any other frequency or voltage found in residential, commercial or manufacturing settings.

As used herein, a “switch” is a switch which applies a force to cause two or more pieces of metal to come into contact or disengage so that an electrical circuit may be opened or closed.

As used herein, the term “rocker switch” means a switch capable of being set in multiple positions to direct the flow of electrical current.

As used herein, an “insulating layer” is a layer of material which inhibits the flow of heat or electrical current.

As used herein, a “power supply board” is a board or plate structure on which components used to construct an electrical power supply are mounted, secured, or affixed.

As used herein, “hollow” means having a gap, space, cavity, channel, empty space, or depression.

As used herein, a “channel” is a path, passage, empty space, or hollowed or partially hollow portion.

As used herein, a “constant temperature” or “constant temperature range” refer to a specified minimum and maximum values of temperature.

As used herein, a “thermostat” is a device for regulating the temperature of a system so that the system's temperature is maintained at a constant temperature or within a specified temperature range

As used herein, a “thermal electric device” is a device which transforms electrical current to heat, one example of which is a heating pad.

As used herein, a “hot plate” is a plate of conductive or partially conductive material which allows heat to pass to the food-heating surface. The hot plate may either generate heat or conduct heat from another device that generates heat.

As used herein, a “thermal barrier” is a layer of material which directs heat.

As used herein, a “food heating surface” is a surface which conducts heat, continuously or intermittently, to food or containers holding food.

As used herein, a “support member” is a leg or other support member that functions to support a food heating surface and non-heated furniture surface.

As used herein, a “control support member” is a support member which contains a device or apparatus that controls electrical circuitry.

### DETAILED DESCRIPTION OF EMBODIMENTS OF THE INVENTION

For the purpose of promoting an understanding of the present invention, references are made in the text hereof to exemplary embodiments of a heated serving apparatus, only some of which are depicted in the figures. It should nevertheless be understood that no limitations on the scope of the invention are thereby intended. One of ordinary skill in the art will readily appreciate that modifications such as those involving the number of components, positioning of the components relative to one another, materials from which the components are made, the size of the components, and the inclusion of additional elements do not depart from the spirit and scope of the present invention. Some of these possible modifications are mentioned in the following description. In addition, in the embodiments depicted herein, like reference numerals refer to identical structural elements in the various drawings. Therefore, specific details disclosed herein are not to be interpreted as limiting, but rather as a basis for the claims and as a representative basis for teaching one skilled in the art to employ the present invention in virtually any appropriately detailed system, structure, or manner.

Moreover, the term “substantially” or “approximately” as used herein may be applied to modify any quantitative representation that could permissibly vary without resulting in a change in the basic function to which it is related.

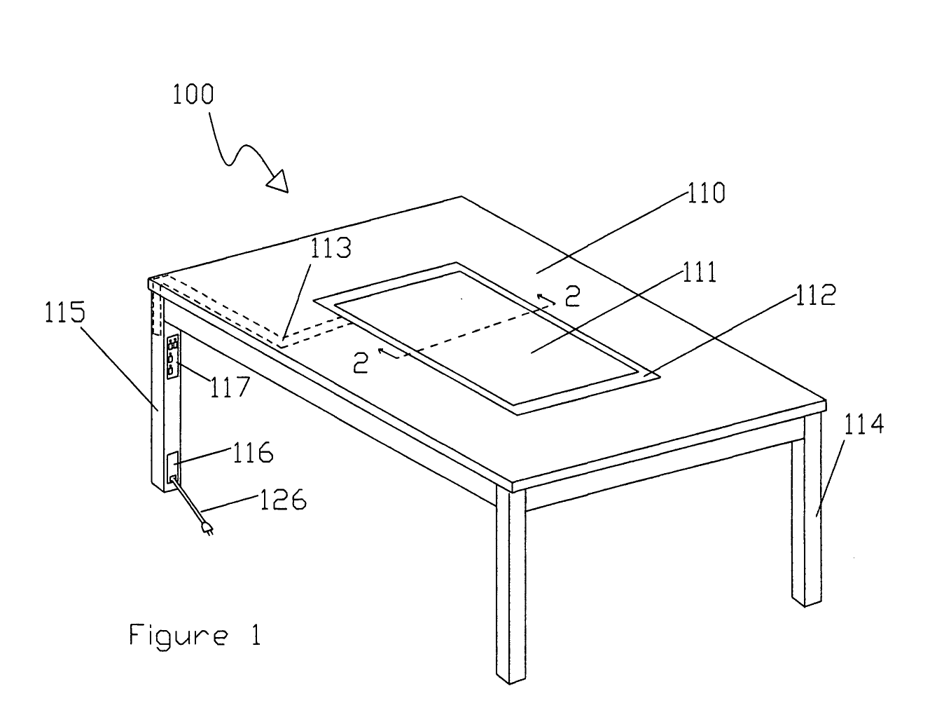

Referring now to the figures, FIG. 1 shows a top perspective view of one embodiment of heated serving apparatus 100. In the embodiment shown, heated serving apparatus 100 is comprised of non-heated furniture surface 110, food heating surface 111 containing recessed compartment 112, a partially hollow channel 113, and a plurality of support members 114, including control support member 115. However, other embodiments may have a single support member 114 which may be the same as control support member 115. Additionally, in other embodiments, support members 114 may be a mounting to a wall or other structure, a shelf, or a bracket. Control support member 115 further includes lower panel 116, control panel 117, and wire 126.

In the embodiment shown, objects such as plates and forks, for which heating is not desired, are placed on non-heated furniture surface 110. In the embodiment shown, non-heated furniture surface 110 is made of wood, but in other embodiments may be made of glass, plexi-glass, laminate products, metal, stone, marble, any other natural or man-made substance known in the art which may serve as a rigid or semi-rigid surface for serving food and placing objects thereon, including combinations thereof. In addition, non-heated furniture surface 110 can further include one or more additional layers (not shown). The additional layer or layers can be ornamental or non-ornamental. In one embodiment, an ornamental glass layer is included, but in other embodiments the additional layer may be plexi-glass, laminate products, metal, stone, marble, or combinations thereof.

Also visible in FIG. 1 is wire 126 which is adapted to be electrically connected to a power source (not shown). In the embodiment shown, the power source is a 120 volt alternating current U.S. household power source, but may be another voltage source, such as 110-Volt, 240-Volt, 208-Volt or any other voltage source or a battery, lithium battery, solar panel, generator, or any other energy source known in the art. In an embodiment in which a battery is contained within control support member 115, wire 126 would not be necessary.

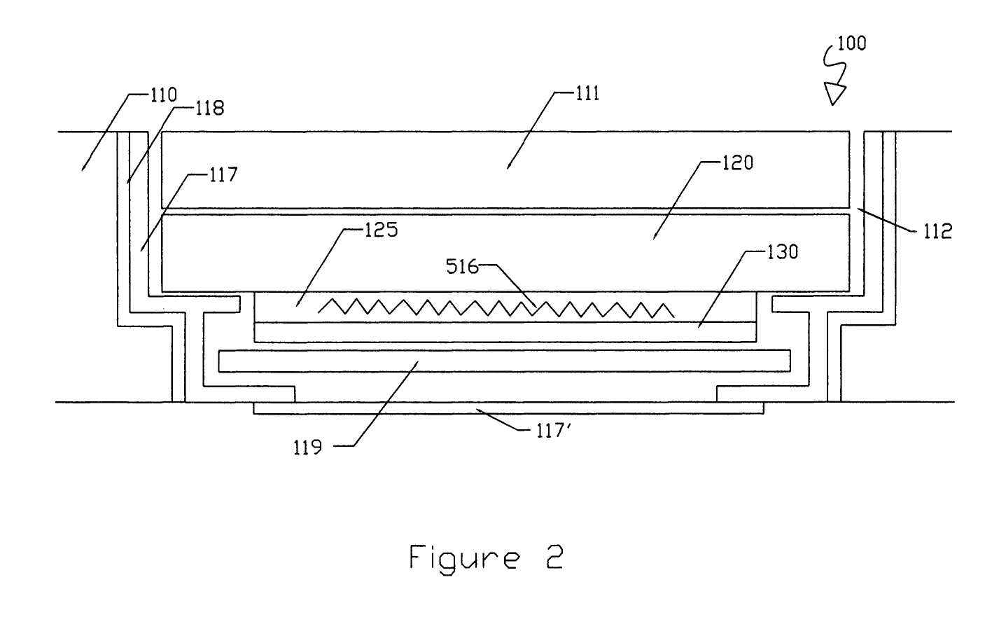

FIG. 2 shows a cross-sectional view of one embodiment of recessed compartment 112 of the embodiment of heated serving apparatus 100 shown in FIG. 1 taken along line 2-2. Recessed compartment 112, insulating layer 118, lower insulating layer 119, box structure side 117 and box structure bottom 117′ (collectively referred to as box structure 117, 117′), thermal barrier 130, thermal electric device 125, hotplate 120, electrical circuitry 516, non-heated furniture surface 110, and food heating surface 111 can all be seen. Insulating layer 118, box structure 117, 117′, thermal barrier 130, thermal electric device 125, hot plate 120, and food heating surface 111 fit within recessed compartment 112 so that food-heating surface 111 is substantially flush with non-heated furniture surface 110. However, it should be understood that food heating surface 111 could alternately be recessed or extend above non-heated furniture surface 110. Furthermore, lower insulating layer 119 is shown within box structure 117, 117′, but could alternately be partially within or external to box structure 1 17, 117′ without departing from the scope of the invention.

Also shown in FIG. 2 are box structure side 117 and box structure bottom 117′. Box structure side 117 is positioned within recessed compartment 112 and maintains the structural integrity of the components contained therein, and box structure bottom 117′ complete box structure 117, 117′. In the embodiment shown, heated serving apparatus 100 has one (1) box structure 117, 117′ within recessed compartment 112. In one alternate embodiment, heated serving apparatus 100 has two (2) box structures 117, 117′, each of which has the elements described herein and allows each food-heating surface 111 to be controlled independently. However, in alternate embodiments, box structure 117, 117′ could have a plurality of sections of a number other than two, or box structure 117, 117′ may be omitted entirely. Box structure 117, 117′ may be molded, constructed as a single piece, or may be formed or constructed from more than one piece and then connected to form a partial or complete box structure 117, 117′. In the embodiment shown, box structure 117, 117′ is made from extruded aluminum, but may be made of copper, stainless steel, galvanized steel, resins, ceramic, stone, any other natural or man made material capable of insulating heat, including combinations thereof.

Also visible in FIG. 2 is insulating layer 118. Insulating layer 118 prevents heat from being transferred from recessed compartment 112 to non-heated furniture surface 110. The embodiment shown further includes lower insulating layer 119 which further reduces the amount of heat transferred to non-heated furniture surface 110. However, alternate embodiments of heated serving apparatus 100 do not include second insulating layer 119. In the embodiment shown, insulating layer 118 and second insulating layer 119 are cut to a thickness of between one thirty-second of an inch ( 1/32″) and two inches (2″). In the embodiment shown, insulating layer 118 and second insulating layer 119 are made of fiberglass insulation, but can alternately be made of aluminum, rubber, resin, insulating foam, insulating acetate, acrylic, ceramic, glass, melamine, mica, neoprene, phenolics, mylar, polyester, polyolefins, polystynrene, polyurethane, polyurethane, PVC silicone, PVC silicone/fiberglass, silicone rubber, teflonthermoplastics, insulating papers, or any other material which has insulating properties and may be formed to fit within recessed compartment 112, including combinations thereof. In an alternate embodiment of food heating apparatus 100, box structure 117, 117′ is made of an insulating material, such as ceramic, making a separate box structure 117, 117′ and insulating layer 118 and/or second insulating layer 119 unnecessary.

Also shown in FIG. 2 is thermal barrier 130 between second insulating layer 1 19 and thermal electric device 125. Thermal barrier 130 directs heat from thermal electric device 125 (described in detail infra) upward toward food heating surface 111. In the embodiment shown, thermal barrier 130 is one quarter inch (¼″) thick and made of fiberglass insulation with vermiculite backing material, but can alternately be made of aluminum, rubber, resin, insulating foam, insulating acetate, acrylic, ceramic, fiberglass, glass, melamine, mica, neoprene, phenolics, polyester, mylar, polyolefins, polystynrene, polyurethane, PVC silicone, fiberglass, polyurethane, PVC silicone/fiberglass, silicone rubber, teflonthermoplastics, insulating papers, or any other material which has insulating properties, including combinations thereof.

Also shown in FIG. 2 are thermal electric device 125, hot plate 120, and food heating surface 111. Thermal electric device 125 is electrically connected to a power source (not shown; discussed in detail infra) and generates heat which is transferred to hot plate 120. Hot plate 120 transfers the heat to food heating surface 111 and helps distribute the heat evenly to food heating surface 111. However, alternate embodiments need not include hot plate 120.

In the embodiment shown, thermal electric device 125 is a device which contains electrical circuit 516 mounted in silicone and is mounted to the bottom of hot plate 120 with an adhesive, one example of which is a heating pad. Hot plate 120 is made of a material which conducts heat. In this embodiment, hot plate 120 is made of an alloy containing nickel and aluminum, specifically, 3003-H14. However in other embodiments, hot plate 120 may be made of aluminum, a different aluminum alloy, any metal, ceramic, stone or glass material capable of conducting heat to food heating surface 111. In the embodiment shown, food heating surface 111 is a tempered glass capable of conducting heat. However, in other embodiments granite, slate, stone, ceramic, steel, copper, laminated glass, insulated glass, fire-resistant glass, appliance glass, fiberglass, or any other material capable of conducting heat or combinations thereof may be substituted. Hot plate 120 is also electrically connected to at least one microprocessor (not shown; discussed in detail infra). Additionally, hot plate 120 has at least one sensor (not shown; discussed in detail infra) positioned at least partially within it or between hot plate 120 and food heating surface 111 which measures the temperature of food heating surface 111. The microprocessor receives input from the sensor, and if the temperature of food heating surface 111 is outside of a desired range, the microprocessor sends an electric signal to a relay (not shown; discussed in detail infra) to close a switch (not shown; discussed in detail infra) to complete the electrical circuit (not shown; discussed in detail infra) which supplies current to hotplate 120. The embodiment shown includes only one (1) hotplate 120. However, other embodiments may include two (2) sections to enable the two (2) halves of food heating surface 111 to be separately maintained within a specified temperature range. In the embodiment shown, hotplate 120 is made from a nickel-aluminum alloy, specifically 3003-H14, but could alternatively be made of galvanized steel, stainless steel, other aluminum alloys, aluminum, copper, granite, slate, stone, and any other sufficiently durable, corrosion-resistant, and conductive material, including combinations thereof. Each half would then have its own sensor or sensors.

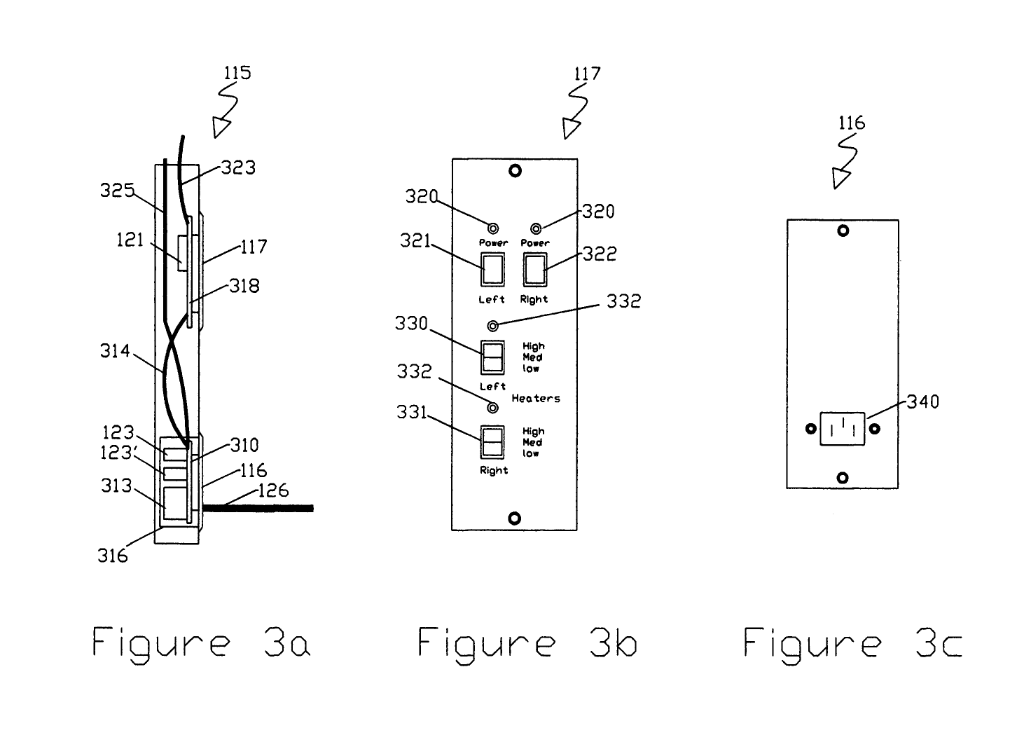

FIG. 3a shows a side view of one embodiment of control support member 115, which is a table leg in the embodiment shown, and on which one embodiment of control panel 117 and lower panel 116 can each be seen. In the embodiment shown, control support member 115 is made of wood, but in other embodiments may be made of any natural or man made material from which furniture may be constructed, and may be solid, hollow or have one or more recessed chambers.

Also visible in FIG. 3a are sensor wire 323, hot plate wire 325, low voltage wire 314, wire 126, microprocessor 121, control circuit board 318, relays 123, 123′, and step-down transformer 313, power supply board 310. Sensor wire 323 electrically connects the sensor (not shown) to control circuit board 118. Thermal electric device wire 325 electrically connects the thermal electric device (not shown) to power supply board 310. Low voltage wire 314 electrically connects control circuit board 318 to power supply board 310. Wire 126, as provided supra, electrically connects heated serving apparatus 100 to a power source (not shown).

FIG. 3b is a front view of one embodiment of control panel 117 positioned on the embodiment of control support member 115 shown in FIG. 3a in which the food heating surface (not shown) is divided into two (2) halves. In the embodiment shown, control panel 117 includes left power button 321, right power button 322, power indicator lights 320, left temperature control 330, right temperature control 331, and indicator lights 332. In the embodiment shown, left power button 321 and right power button 322 control the delivery of power to each half of the food heating surface and allow the left and right sides to be separately controlled. In the embodiment shown, left power button 321 and right power button 322 are each a rocker switch, but could be any type of switch capable of having an on/off function. Also shown are two (2) power indicator lights 320 which indicate whether power is flowing to the food heating surface. Control panel 117 further includes left temperature switch 330 and right temperature switch 331 which each regulate the flow of current to the left and right sides of the food heating surface and allow the left and right sides to be separately controlled by flowing through appropriate portions of the electrical circuit (discussed in detail infra). Each temperature switch 330, 331 may be set to a “high,” “medium,” or “low” temperature range to regulate the flow of alternating current to the thermal electric device (not shown). In the embodiment shown, temperature switches 330, 331 are each a three-position rocker switch, but could be any type of switch capable of having multiple positions. Also visible are indicator lights 332 which indicate that the temperature of the food heating surface is being controlled. Other embodiments of the heated serving apparatus may not include indicator lights 320, 332, may include more or fewer indicator lights 320, 332, may not include temperature switches 330, 331 (in which the heating serving apparatus would only have an on/off function and be capable of being heated to a single temperature or temperature range), include only one (1) power switch 321 and temperature switch 330 (for an embodiment with a single food heating surface, or include a greater number of power switches 321, 322 and temperature switches 330, 331 for those embodiments with more than two (2) independently operated food heating surfaces. Other embodiments may further have fewer or additional temperature ranges from which a user may select.

In the embodiment shown, an amber light is used for power indicator lights 332 to indicate that the relay (not shown) has been turned on and current is being supplied to the food heating surface. However, it should be understood that the choice of amber is only one example of a light that could be used to indicate that current is being supplied to the food heating apparatus. Other colors, white light, or any other indicator can be used.

FIG. 3c is a front view of one embodiment of lower panel 116, also positioned on the embodiment of control support member 115 shown in FIG. 3a. Lower panel 116 functions as a face plate and, along with insulated five-sided electrical box (indicated by number 316 in FIG. 3a) encase electrical components within control support member 115 to ensure that the heated serving apparatus is UL compliant and protect the heated serving apparatus from the electrical components. In the embodiment shown, lower panel 116 and electrical box 316 are made of galvanized steel, but can be made of any other material or shape capable of separating low and high voltage. Outlet 340 is positioned on lower panel 116. In the embodiment shown, face plate 116 is also made of galvanized steel, but can also be made of any other material capable of separating low and high voltage.

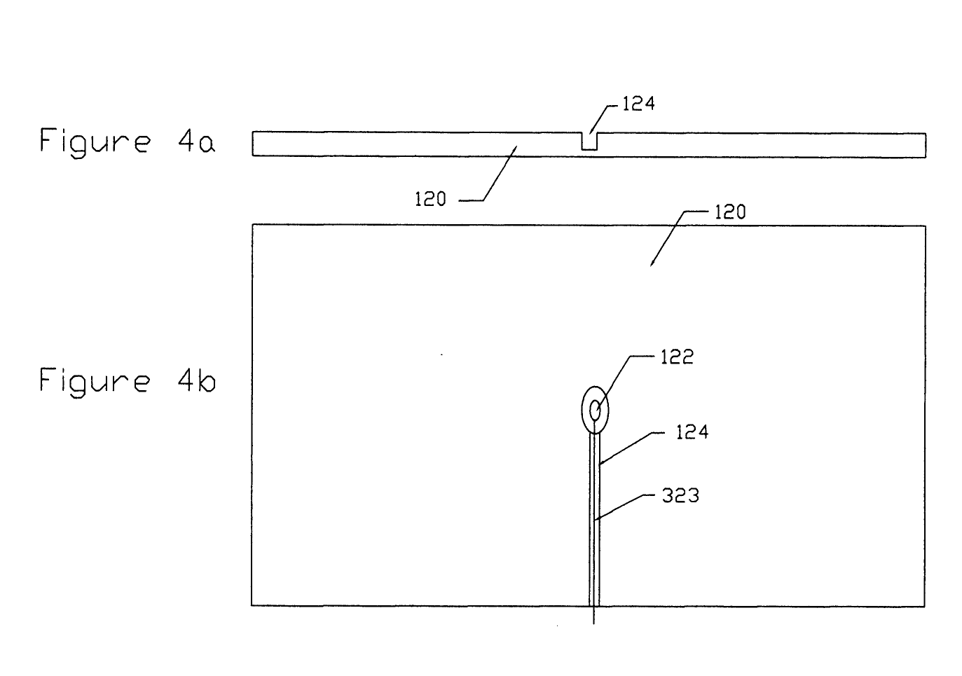

FIGS. 4a and 4b show a side view and top view respectively of one embodiment of hot plate 120 including sensor 122, groove 124 to facilitate insertion of one (1) electrical sensor 122 within hotplate 120, and sensor wire 323 (discussed supra with respect to FIG. 3a). In the embodiment shown, groove 124 contains wire 323 and electrical sensor 122 suspended in electrical caulk or other insulating material.

After exiting hot plate 120, sensor wire 323 passes through the channel 113 to control support member 115 (both shown in FIG. 1). Thermal electric device 325 (visible in FIG. 3a) also passes through the same channel. As stated supra, channel 113 is a hollow portion within the various components of the heated serving apparatus, but can alternately be a passage, empty space, or partially hollow portion that allows sensor wire 323 and hot plate wire 325 to pass therethrough. In an alternate embodiment, the channel is large enough to also allow a tubing (not shown) to be positioned therein. The tubing encases sensor wire 323 and hot plate wire 325. In one embodiment, the tubing is made of bendable copper, but can be made of any comparable material.

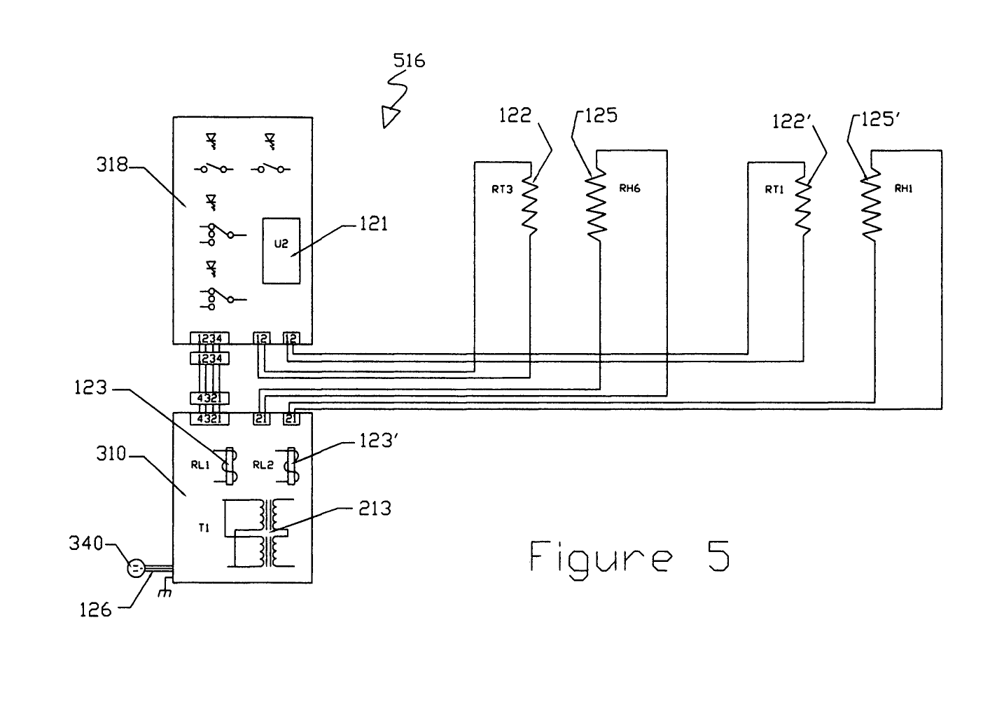

FIG. 5 is an electrical circuit diagram of one embodiment of electrical circuitry 516 used to control the heat of the heated serving apparatus (not shown) which has two (2) food heating surfaces (not shown). Control board 318, power supply board 310, microprocessor 121, relays 123, 123′, transformer 213, left sensor 122, right sensor 122′, left thermal electric device 125, and right thermal electric device 125′ can all be viewed.

In the embodiment shown, relays 123, 123′ are each a switch controlled by microprocessor 121, which is located on control board 318. Sensors 122, 122′ are positioned at or near left thermal electric device 125 and right thermal electric device 125′ so as to be able to convey temperature readings to microprocessor 121. Microprocessor 121 sends a signal to relay 123 to open or close. Focusing only on the left food heating surface, when the signal is that sensor 122 is within a specified temperature range, relay 123 is left open. When the signal is that sensor 122 is below the specified temperature range, relay 123 is switched closed, completing the electric circuit and delivering current to thermal electric device 125. The right food heating surface is controlled in the same manner, but independent of the left food heating surface. Other embodiments of the invention may have more than one (1) microprocessor 121 or relay 123,123′, and may operate using varying levels of current.

In one embodiment, microprocessor 121 reads the temperature from sensors 122, 122′ approximately eight (8) times per second. This maintains the temperature of the food-heating surface within one degree Fahrenheit (1° F.) of the set temperature range. However, the reading could be any number of times per second or seconds per reading that ensures accurate readings of the temperature of the food heating surface. Specific alternate embodiments take readings fifty (50) times per second, one hundred (100) per second, and one (1) per second. A reading taken once per second results in accuracy of two and one-half to three degrees Fahrenheit (2.5-3° F.).

In the embodiment shown, electrical sensors 122, 122′ are each a thermister, but could alternately be an RTD build into a circuit board or a thermal couple.

In the embodiment shown, power to the heated serving apparatus is provided by plugging wire 126 into outlet 340. Electric current is thus provided to power supply board 310. Power supply board 310 contains step down transformer 213 or other apparatus that converts a least a portion of current transferred from the power source (not shown) from alternating current 120 voltage to low voltage 12 volt direct current. In the embodiment shown, the power supply is connected to control panel 318 by 18 gauge copper wire. Low voltage 12 volt direct current is transferred directly from the power supply by a low voltage wire to control board 318. A high voltage conducting wire transfers high voltage current from the power supply, which is not passed through step-down transformer 213 to electrical circuit 516 and directly to relays 123, 123′.

While the heating serving apparatus has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications obvious to one of ordinary skill in the art.

What is claimed is:

1. An apparatus comprised of:
a non-heated furniture surface having a top surface, a bottom surface, and a recessed compartment at least partially within said top surface;
a food heating surface positioned at least partially within said recessed compartment of said non-heated furniture surface;
a thermal electric device below said food heating surface to convert an electrical current to heat;
at least one support member adapted for supporting said non-heated furniture surface structure at said bottom surface of said non-heated furniture surface; and
at least one microprocessor in electrical contact with said thermal electric device and adapted to maintain said food heating surface within a constant temperature range, said apparatus adapted to electrically engage a power supply.

2. The apparatus of claim, wherein said recessed compartment, further includes at least one insulating layer positioned within said recessed compartment wherein said insulating layer is made of a material selected from a group comprised of aluminum, rubber, resin, insulating foam, insulating acetate, acrylic, ceramic, fiberglass, glass, melamine, mica, neoprene, phenolics, polyester, mylar, polyolefins, polystynrene, polyurethane, PVC silicone, fiberglass, polyurethane, PVC silicone/fiberglass, silicone rubber, teflonthermoplastics, insulating papers, and combinations thereof.

3. The apparatus of claim 1, wherein said food-heating surface selected from a group comprised of glass, metal, stone, and combinations thereof.

4. The apparatus of claim 1 further comprising a hot plate to evenly disperse heat, said hot plate having a top surface and a bottom surface, said top surface of said hot plate in contact with said food heating surface.

5. The apparatus of claim 1 further comprising at least one electrical sensor, wherein said at least one electrical sensor conveys a temperature of said food heating surface to said microprocessor, and if said temperature of said food heating surface is outside of a specified temperature range, said microprocessor sends a signal to a relay to control a switch to control flow of current to said thermal electric device.

6. The apparatus of claim 1, wherein said food heating surface further includes a thermal barrier positioned below said thermal electric device and adapted to direct heat from said thermal electric device toward said food heating surface.

7. The apparatus of claim 1, wherein said thermal electric device is a heating pad.

8. The apparatus of claim 1, further comprising a box structure, said box structure at least partially enclosing one or more components selected from a group comprising said food heating surface, and said thermal electric device, and positioned at least partially within said recessed compartment wherein said box structure is made of a material selected from a group comprised of aluminum, galvanized steel, stainless steel, resins, ceramic stone and combinations thereof.

9. The apparatus of claim 8, wherein said box structure is comprised of a box structure side and a box structure bottom.

10. The apparatus of claim 1 further comprising a transformer, said transformer converting at least some portion of alternating current from said power source to direct current.

11. The apparatus of claim 10, wherein said transformer is included within said at least one support member.

12. The apparatus of claim 1 further comprising at least one wire within said channel to carry voltage and currents.

13. The apparatus of claim 12, wherein a first of said at least one wire transfers at least some portion of alternating current to said thermal electric device to produce heat.

14. The apparatus of claim 12, wherein a second of said at least one wire transfers direct current to said microprocessor.

15. The apparatus of claim 1, wherein at least one first light indicates whether power to said apparatus is on.

16. The apparatus of claim 1, wherein at least one second light indicates whether current is flowing to said thermal electric device.

17. The apparatus of claim 1, wherein each of said at least one support member is selected from a group comprised of a leg, a wall, a shelf, and a bracket.

18. An apparatus comprised of:
a non-heated furniture surface having a top surface, a bottom surface, and a recessed compartment and including at least one channel within said non-heated furniture surface, said at least one channel adapted to allow at least one electrical wire pass therethrough;
a food heating surface positioned at least partially within said recessed compartment of said non-heated furniture surface;
a thermal electric device below said food heating surface to convert an electrical current to heat;
at least one support member adapted for supporting said non-heated furniture surface structure at said bottom surface of said non-heated furniture surface;
at least one microprocessor adapted to regulate said food heating surface to maintain a constant temperature range, said apparatus adapted to electrically engage a power supply; and
at least one electrical sensor, wherein said at least one electrical sensor conveys a temperature of said food heating surface to said microprocessor, and if said temperature of said food heating surface is outside of a specified temperature range, said microprocessor sends a signal to a relay to control a switch to control flow of current to said thermal electric device.

19. An apparatus comprised of:
a non-heated furniture surface having a top surface, a bottom surface, and a recessed compartment at least partially within said top surface;
a food heating surface positioned at least partially within said recessed compartment of said non-heated furniture surface;
a heating pad below said food heating surface to convert an electrical current to heat;
at least one leg-support member adapted for supporting said non-heated furniture surface;
a lithium-cadmium battery, said battery providing voltage to said apparatus; and
at least one microprocessor adapted to regulate said food heating surface to maintain said food heating surface within a constant temperature range.
